(19) United States
(12) Patent Application Publication
(10) Pub. No.: US 2026/0194893 A1
(43) Pub. Date: Jul. 9, 2026

(54) DETECTION OF ANOMALIES IN A TECHNICAL SYSTEM BY WAY OF MONITORING USING A PLURALITY OF SENSORS

(71) Applicant: Robert Bosch GmbH, Stuttgart (DE)

(72) Inventor: Andres Mauricio Munoz Delgado, Schoenaich (DE)

(21) Appl. No.: 18/863,829

(22) PCT Filed: May 3, 2023
(86) PCT No.: PCT/EP2023/061648

§ 371 Date: Nov. 7, 2024

(30) Foreign Application Priority Data
May 17, 2022 (DE) 10 2022 204 863.6

(51) Int. Cl. G05B 23/02; G01D 21/02; G06N 20/00

(52) U.S. Cl. CPC G05B 23/0221; G01D 21/02; G05B 23/024; G05B 23/0254; G06N 20/00

(57) ABSTRACT

A method for recognizing anomalies in a technical system whose behavior is monitored by an arrangement including n sensors, comprising the following steps: for each sensor k=1, . . . , n, a time series

$${R}_{k}^{t}$$

of N observations of this sensor for times t=1, . . . , N is recorded; for each time t=1, . . . , N and for the indices i=1, . . . , n and j=1, . . . , n, characteristic variables,

$${K}_{i , j}^{t}$$

which characterize paired conditional probability distributions P_{D}(i|j) of observations of the sensors i and j, are ascertained; a tensor K* of all characteristic variables

$${K}_{i , j}^{t}$$

is mapped by a trained machine learning model to a classification as to whether the behavior of the technical system is normal or abnormal.

### FIELD

The present invention relates to the monitoring by sensors of technical systems for recognizing known and also unknown anomalies.

### BACKGROUND INFORMATION

Complex technical systems, such as vehicles or industrial plants, are monitored by a large number of sensors in order to recognize anomalies in operation. It tends to be difficult to distinguish between anomalies in the monitored technical system and unavoidable disruptions in the monitoring by sensors. The measurement signals detected by the sensors are often subject to noise and their transmission via a network can be delayed.

Moreover, as the number of sensors increases, it becomes more and more likely that the function of individual sensors will be disrupted. In order to recognize anomalies based on specific rules and to eliminate the aforementioned influences, the measurement data would have to be smoothed to a very high degree, wherein a great deal of information would be lost.

### SUMMARY

The present invention provides a method for recognizing anomalies in a technical system, the behavior of which is monitored by an arrangement comprising n sensors.

Within the framework of the present invention, for each sensor k=1, . . . , n a time series

$${R}_{k}^{t}$$

of N observations of this sensor for times t=1, . . . , N is recorded. For each time t=1, . . . , N and for the indices i=1, . . . , n and j=1, . . . , n, a characteristic variable

$${K}_{i , j}^{t}$$

which characterizes a paired conditional probability distribution P_{D}(i|j) of observations of the sensors i and j is ascertained. P_{D}(i|j) thus describes probabilities, based on a given situation in which sensor j provides a specific observation, that sensor i will provide certain specific observations. For example,

$${K}_{i , j}^{t}$$

can be ascertained as the mean value of a distribution of observations of sensor i for all time steps at which the observation of sensor j has the same value as in time step t. Since the observations have real values, it is possible that no two observations are exactly the same, such that the “same value” requirement can be relaxed to mean in particular, “within an interval of ±E from the value in the time step t”, for example. Alternatively or in combination therewith, the characteristic variable

$${K}_{i , j}^{t}$$

can also relate to any other properties of the paired conditional probability distribution P_{D}(i|j) and, for example, comprise a characteristic variable of the descriptive statistics of P_{D}(i|j), such as a standard deviation if P_{D}(i|j) is a Gaussian distribution. The distribution P_{D}(i|j) can also be ascertained or approximated in any other way, and the characteristic variable

$${K}_{i , j}^{t}$$

can then be ascertained therefrom.

A tensor K* of all characteristic variables

$${K}_{i , j}^{t}$$

is thus a “fingerprint” of the behavior of the technical system, which records the inherent correlations between the individual sensor modalities.

This “fingerprint” K* is mapped by a trained machine learning model to a classification as to whether the behavior of the technical system is normal or abnormal. This classification can take any form. For example, it can be binary or contain one or more real-value scores in relation to certain aspects of the operation.

It has been recognized that the physical configuration of many technical systems defines physical interactions between the measured variables detected by different sensors and thus causes temporal correlations between these measured variables. If, for example, a flow of a fluid medium is registered at one end of a pipe, this correlates with a change in temperature being registered a little later at the other end of the pipe. The presence of such a correlation can then be interpreted as a signal as to whether the technical system is functioning normally. If, for example, the pipe is leaking or torn off and the medium flowing through at one end is not reaching the other end, but instead is pouring into the factory floor, the correlation between the changed temperature and the flow rate is suddenly missing.

Therefore, according to an example embodiment of the present invention, it is advantageous to select at least two sensors for measured variables, between which the physical configuration of the technical system in the nominal state of this system facilitates a physical interaction.

The one measured variable can in particular, for example, be a measure of the amount of energy fed to or present in the technical system, and the other measured variable can then be a measure of the amount of energy present or an energy output by the technical system. In the aforementioned example with the pipe, a warm fluid fed at one end of the pipe introduces energy into the pipe, and when the pipe is heated thereby, it in turn radiates energy. For example, an increased motor current of an electrical machine will also manifest itself in an increased amplitude of vibrations of this machine. Since energy is a physical conserved quantity, in many technical systems there are temporal correlations between measured values provided by different sensors. These correlations do not need to be explicitly analyzed and formulated in order to use them to monitor the technical system for normal function. It is sufficient that, in normal operation, the correlations are simply physically present, such that they can be learned by the machine learning model.

In a further advantageous example embodiment of the present invention, at least two further sensors are selected for further measured variables, between which the physical configuration of the technical system excludes a physical interaction in the nominal state of this system. For example, pressures in unconnected regions or containers should not be correlated with one another. However, if such a correlation does exist, this may indicate that there is an unwanted leak between the regions or containers.

Therefore, for example, the further sensors can in particular be arranged on different sides of a barrier that prevents the physical interaction between the further measured variables in the nominal state of the technical system.

In particular, the machine learning module can, for example, learn the normal behavior of the technical system and then classify anything that is “somehow different” as an anomaly, even if the anomaly only relates to a small signal component of one or more measurement signals detected by the sensors. This is somewhat analogous to an intruder alarm system that does not trigger an alarm when a rightful occupant hammers a nail into the wall, but does recognize the noises generated by manipulating the door lock with lock-picking tools as an attempted break-in and triggers the alarm.

The technical system can be, for example, a vehicle or an industrial plant that processes one or more reactants into one or more products in one or more processing steps. Both in vehicles and in industrial plants, a large number of measured values are already detected by sensors and can be better evaluated with regard to possible anomalies using the method proposed here. A vehicle in particular provides a large number of correlations via its body, in and on which the sensors are distributed in a comparatively small space, which can be used for recognizing anomalies. In an industrial plant, such correlations are provided, for example, by material flows of reactants and/or products through the plant. Control devices in vehicles and “plant historians” in industrial plants also automatically log a large number of measured values. These protocols can be used, for example, in conjunction with the knowledge that anomalies have or have not occurred at certain times, to obtain labeled training data for both the normal state and the abnormal state. This labeled training data can be used to train the machine learning model in a monitored manner. For example, paired conditional probability distributions P_{D}(i|j) can be ascertained and/or approximated using training data. How far a machine learning model can look into the past is determined by the selected architecture parameters, such as the widths of filter kernels in convolutional layers.

In a further advantageous example embodiment of the present invention, a control signal is formed from the classification provided by the machine learning model. The technical system is controlled with this control signal. For example, in response to an anomaly being determined in a vehicle, the maximum speed can be reduced, the execution of certain risky driving maneuvers (such as overtaking maneuvers) can be prevented or the vehicle can be brought to a stop on a pre-planned emergency stop trajectory. An industrial plant can, for example, be switched to a safe mode, in which the throughput of the plant is reduced to a minimum. In this safe mode, the plant can also be operated manually if the automatic control system fails, for example.

As mentioned above, the machine learning model can be trained using labeled training examples of tensors K*. However, specially labeled training examples for anomalies are often scarce, since the technical systems usually work so well that anomalies are rare.

Therefore, the present invention provides a method for training a machine learning model for use in the method described above, which requires only a few labeled training examples.

Within the framework of this method of the present invention, training examples for tensors K* of characteristic variables

$${K}_{i , j}^{t} ,$$

which characterize paired conditional probability distributions P_{D}(i|j) of observations of the sensors i and j, are provided. For these training examples, it is not yet necessary to know whether they relate to normal or abnormal behavior of the technical system.

According to an example embodiment of the present invention, a distribution of disruptions p is provided, for which it is known that they modify a tensor K* only in a way that can also occur in normal operation of the technical system.

An example of such disruptions p is additive, normally distributed noise, as can also be contained in the observations provided by the sensors.

Further examples are a stochastic zeroing of non-diagonal elements of the tensor K*, a replacement of elements

$${K}_{i , j}^{t}$$

at the level t by elements

$${K}_{i , j}^{t + 1} , {K}_{i , j}^{t - 1}$$

at the levels t+1 or t−1, and/or an interchange of levels t, t′ of the tensor K*. These disruptions simulate errors that can occur during detection by sensors and the transmission of measurement data via a network. A mixing of elements

$${K}_{i , j}^{t}$$

at the level t with elements

$${K}_{i , j}^{t + 1} , {K}_{i , j}^{t - 1}$$

at levels t+1 or t−1 can be caused, for example, by inaccurate time synchronization between sensors. Poor time synchronization or problems with the transmission of measurement data via a network can, for example, lead to the interchange of levels t, t′. Sporadic sensor errors can manifest themselves, for example, in missing non-diagonal elements in the tensor K*.

With the disruptions p, so-called positive and negative pairs for the process of contrastive learning can be created. Contrastive learning is self-monitored learning based on positive and negative examples that are known to be similar or dissimilar to one another.

Positive pairs

$$( {K}_{{p}_{1}}^{*} , {K}_{{p}_{2}}^{*} )$$

of variations

$${K}_{{p}_{1}}^{*} and {K}_{{p}_{2}}^{*}$$

are generated by applying two disruptions p₁ and p₂ sampled from the distribution to one and the same training example K*. The variations

$${K}_{{p}_{1}}^{*} and {K}_{{p}_{2}}^{*}$$

in these pairs therefore only differ with regard to disruptions, as they also occur in the normal operation of the technical system and monitoring by sensors. Therefore, the machine learning model should recognize these variations

$${K}_{{p}_{1}}^{*} and {K}_{{p}_{2}}^{*}$$

as being similar to one another.

Negative pairs

$$( {K}_{{p}_{1}}^{* ′} , {K}_{{p}_{2}}^{* ′′} ) of variations {K}_{{p}_{1}}^{* ′} and {K}_{{p}_{2}}^{* ′′}$$

are generated by applying two disruptions p₁ and p₂ sampled from the distribution to two different training examples K*′ and K*″. Thus, the variations

$${K}_{{p}_{1}}^{* ′} and {K}_{{p}_{2}}^{* ′′}$$

in these pairs differ not only by the usual disruptions mentioned, but are variations of two completely different examples. Thus, the machine learning model should recognize these variations

$${K}_{{p}_{1}}^{* ′} and {K}_{{p}_{2}}^{* ′′}$$

as being dissimilar to one another.

In order to train the machine learning model precisely for this, by means of the machine learning model to be trained processing products

$$V ( {K}_{{p}_{1}}^{*} ) , V ( {K}_{{p}_{2}}^{*} ) , V ( {K}_{{p}_{1}}^{* ′} ) and V ( {K}_{{p}_{2}}^{* ′′} )$$

are in each case generated from the variations

$${K}_{{p}_{1}}^{*} , {K}_{{p}_{2}}^{*} , {K}_{{p}_{1}}^{* ′} and {K}_{{p}_{2}}^{* ′′} .$$

This does not necessarily have to be the final output of the machine learning model, which recognizes the classification with regard to the normal or abnormal state. Instead, the machine learning model can, for example, comprise a feature extractor that extracts features from the tensor K* and a classification head that maps these features to the desired classification of the technical system's behavior. The feature extractor can, for example, comprise a sequence of a plurality of convolutional layers that convert their particular input into a dimension-reduced feature map by applying one or more filter kernels. The processing products

$$V ( {K}_{{p}_{1}}^{*} ) , V ( {K}_{{p}_{2}}^{*} ) , V ( {K}_{{p}_{1}}^{* ′} ) and V ( {K}_{{p}_{2}}^{* ′′} )$$

can then be formed by the feature extractor.

Within the framework of contrastive learning, parameters that characterize the behavior of the machine learning model are now optimized with the aim that
a similarity of processing products

$$V ( {K}_{{p}_{1}}^{*} ) and V ( {K}_{{p}_{2}}^{*} )$$

relating to positive pairs

$$( {K}_{{p}_{1}}^{*} , {K}_{{p}_{2}}^{*} )$$

is maximized and
a similarity of processing products

$$V ( {K}_{{p}_{1}}^{* ′} ) and V ( {K}_{{p}_{2}}^{* ′′} )$$

relating to negative pairs

$$( {K}_{{p}_{1}}^{* ′} , {K}_{{p}_{2}}^{* ″} )$$

is minimized.

This means that the feature extractor of the machine learning model is trained to place processing products

$$V ( {K}_{{p}_{1}}^{*} ) and V ( {K}_{{p}_{2}}^{*} ) ,$$

which are based on positive pairs

$$( {K}_{{p}_{1}}^{*} , {K}_{{p}_{2}}^{*} ) ,$$

close to one another in the latent space of its output. It is simultaneously trained to place processing products

$$V ( {K}_{{p}_{1}}^{* ′} ) and V ( {K}_{{p}_{2}}^{* ″} )$$

that are based on negative pairs

$$( {K}_{{p}_{1}}^{* ′} , {K}_{{p}_{2}}^{* ″} )$$

far away from one another in this latent space. Thus, the processing product

$$V ( {K}_{{p}_{1}}^{*} )$$

can correspond to a point zᵢ in latent space, and the processing product

$$V ( {K}_{{p}_{2}}^{*} )$$

for the same positive pair can correspond to a point zⱼ in latent space. An exemplary cost function that measures whether the points zᵢ and zⱼ are close to one another is the NT-Xent-Loss (“normalized temperature-scaled cross entropy):

$${L}_{i , j} = - log ( \frac{exp ( \frac{Ψ ( {z}_{i} , {z}_{j} )}{τ} )}{{\sum }_{k} {1}_{[ k \neq i ]} exp ( \frac{Ψ ( {z}_{i} , {z}_{k} )}{τ} )} ) ,$$

where the function Ψ measures the similarity and τ is a temperature parameter. The temperature parameter τ can in particular be varied as a function of the number of epochs, for example according to an “annealing plan.”

Thus, the machine learning model can thus complete a large part of its training in this way in a self-monitored manner without having to use labeled training examples.

For example, the classification head can then be trained in a monitored manner using training examples K* which are labeled with target classifications. Since the classification head only makes up a small part of the machine learning model, in particular in relation to the number of parameters to be optimized, a comparatively small number of labeled training examples is sufficient for this training. In this context, it is also particularly advantageous that the classification head receives as input a processing product that has already been well pre-sorted as a result of the self-monitored training. Thus, the classification head does not have to rectify something that was previously missed through increased training effort.

The present invention also provides a further method for training a machine learning method for use in the method described above. In contrast to the contrastive learning described above, this method uses normal monitored training.

Within the framework of this method of the present invention, training examples for tensors K* of characteristic variables

$${K}_{i , j}^{t}$$

are provided, which characterize paired conditional probability distributions P_{D}(i|j) of observations of the sensors i and j. These training examples K* relate to normal behavior of the technical system.

A distribution of disruptions p* is now provided, for which it is known that they modify a tensor K* in a way that is not to be expected in normal operation of the technical system. An example of such disruptions is uniformly distributed noise.

By applying disruptions sampled from the distribution p* to training examples K*, variations K* are generated. The machine learning model is trained in a monitored manner using the training examples K* for normal behavior of the technical system, and using the variations K* as training examples for abnormal behavior of the technical system.

With this method of the present invention, the machine learning model can be trained directly on the desired classification task in one step, provided that a suitable distribution of disruptions p* is available for the particular application. In contrast, if such a distribution of disruptions p* is not available or difficult to model, the contrastive learning approach described above can be utilized. An important advantage of contrastive learning is that it does not rely on modeling the disruptions p*.

Optionally, within the framework of this method, the training examples K* can be augmented by applying the disruptions p discussed in connection with contrastive learning to further variations, which can then be used as further training examples for normal behavior within the framework of monitored learning.

Further measures improving the present invention are explained in more detail below, together with the description of the preferred exemplary embodiments of the present invention, with reference to figures.

### DETAILED DESCRIPTION OF EXAMPLE EMBODIMENTS

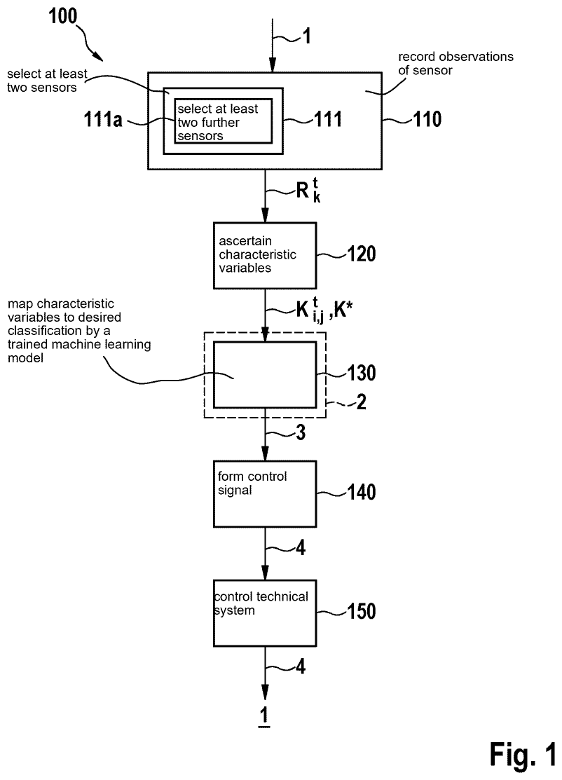

FIG. 1 shows an exemplary embodiment of the method 100 for recognizing anomalies in a technical system 1, according to the present invention.

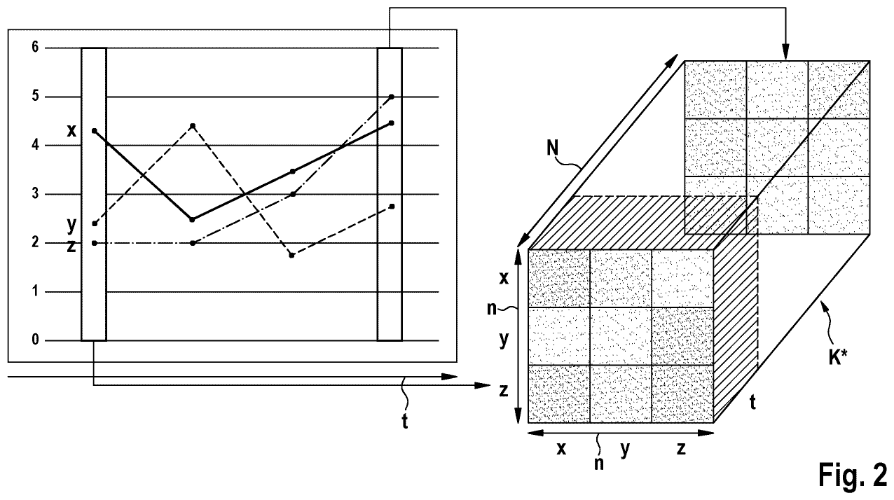

FIG. 2 shows an illustration of a tensor K* of characteristic variables

$${K}_{i , j}^{t} ,$$

according to an example embodiment of the present invention.

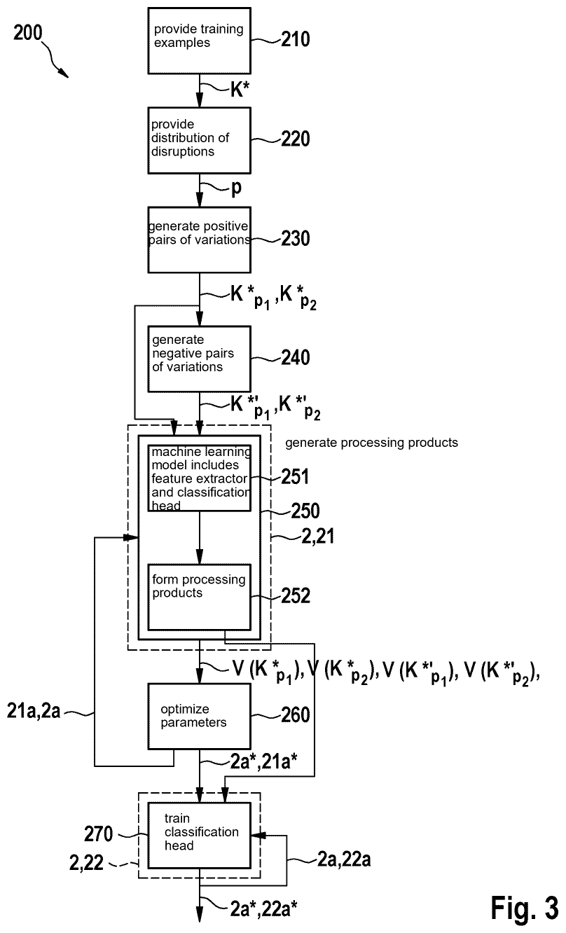

FIG. 3 shows an exemplary embodiment of the method 200 for training a machine learning model 2, according to the present invention.

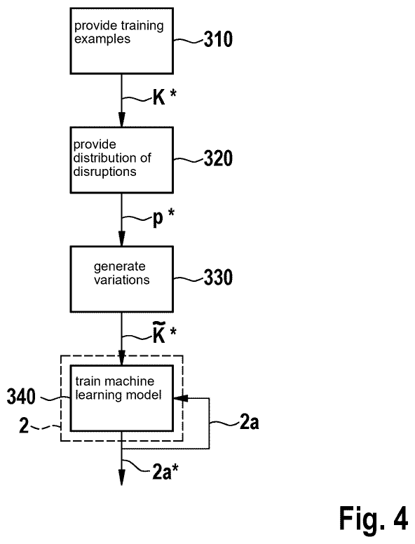

FIG. 4 shows an exemplary embodiment of the method 300 for training a machine learning model 2, according to the present invention.

### DETAILED DESCRIPTION OF EXAMPLE EMBODIMENTS

FIG. 1 is a schematic flowchart of an exemplary embodiment of the method 100 for recognizing anomalies in a technical system 1. The behavior of this system 1 is monitored by an arrangement comprising n sensors.

In step 110, for each sensor k=1, . . . , n a time series

$${R}_{k}^{t}$$

of N observations of this sensor for times t=1, . . . , N is recorded.

According to block 111, at least two sensors can be selected for measured variables, between which the physical configuration of the technical system 1 in the nominal state of this system 1 facilitates a physical interaction. According to block 111a, at least two further sensors can then also optionally be selected for further measured variables, between which the physical configuration of the technical system 1 excludes a physical interaction in the nominal state of this system 1.

In step 120, for each time t=1, . . . , N and for the indices i=1, . . . , n and j=1, . . . , n, characteristic variables

$${K}_{i , j}^{t} ,$$

which characterize paired conditional probability distributions P_{D}(i|j) of observations of the sensors i and j, are ascertained (120).

In step 130, a tensor K* of all characteristic variables

$${K}_{i , j}^{t}$$

is mapped by a trained machine learning model 2 to the desired classification 3 as to whether the behavior of the technical system 1 is normal or abnormal.

In step 140, a control signal 4 is formed from the classification 3 provided by the machine learning model 2.

In step 150, the technical system 1 is controlled using the control signal 4.

FIG. 2 illustrates the formation of the tensor K* based on a simple example with three time-dependent observations x(t), y(t) and z(t). For each time t, assuming that one of the three values x(t), y(t) and z(t) is given, conditional probabilities for the values of all variables (t), y(t) and z(t) can be specified. Characteristic variables

$${K}_{i , j}^{t}$$

that characterize distributions of these paired conditional probabilities are collected in a two-dimensional matrix. All such matrices for all times t together form the tensor K*.

FIG. 3 is a schematic flowchart of an exemplary embodiment of the method 200 for training a machine learning model 2 for use in the method 100 described in connection with FIG. 1. The method 200 is based on contrastive learning.

In step 210, training examples are provided for tensors K* of characteristic variables

$${K}_{i , j}^{t} ,$$

which characterize paired conditional probability distributions P_{D}(i|j) of observations of the sensors i and j.

In step 220, a distribution of disruptions p is provided, for which it is known that they modify a tensor K* only in a way that can also occur in normal operation of the technical system.

In step 230, positive pairs

$$( {K}_{{p}_{1}}^{*} , {K}_{{p}_{2}}^{*} )$$

of variations

$${K}_{{p}_{1}}^{*} and {K}_{{p}_{2}}^{*}$$

are generated by applying two disruptions p₁ and p₂ sampled from the distribution to the same training example K*. Thus, these variations only differ by disruptions p that also occur during normal behavior of the technical system 1 and the data detection by sensors.

In step 240, negative pairs

$$( {K}_{{p}_{1}}^{* ′} , {K}_{{p}_{2}}^{* ″} )$$

of variations

$${K}_{{p}_{1}}^{* ′} and {K}_{{p}_{2}}^{* ″}$$

are generated by applying two disruptions p₁ and p₂ sampled from the distribution to two different training examples K*′ and K*″.

Thus, these variations therefore differ by more than just “normal” disruptions p.

In step 250 (also step 252), by means of the machine learning model (2) to be trained, processing products

$$V ( {K}_{{p}_{1}}^{*} ) , V ( {K}_{{p}_{2}}^{*} ) , V ( {K}_{{p}_{1}}^{* ′} ) and V ( {K}_{{p}_{2}}^{* ″} )$$

are in each case generated from the variations

$${K}_{{p}_{1}}^{*} , {K}_{{p}_{2}}^{*} , {K}_{{p}_{1}}^{* ′} and {K}_{{p}_{2}}^{* ″} .$$

According to block 251, the machine learning model 2 can comprise a feature extractor 21 that extracts features from the tensor K* and a classification head 22 that maps these features to the desired classification of the behavior of the technical system.

In step 260, parameters 2a that characterize the behavior of machine learning model 2 are optimized with the aim of maximizing similarity between

$$( {K}_{{p}_{1}}^{*} ) and V ( {K}_{{p}_{2}}^{*} )$$

while minimizing similarity between

$$V ( {K}_{{p}_{1}}^{* ′} ) and V ( {K}_{{p}_{2}}^{* ″} ) .$$

In particular, these parameters can be the parameters 21a of the feature extractor 21. The fully optimized state of parameters 2a, 21a is denoted by the reference sign 2a*, 21a*.

In step 270, the classification head 22 is trained in a monitored manner using training examples K*, which are labeled with target classifications. This means that the parameters 22a, which characterize the behavior of the classification head 22, are optimized with the aim of mapping the training examples K* from the machine learning model 2 to the particular target classifications. The fully optimized state of these parameters is denoted by the reference sign 22a*.

FIG. 4 is a schematic flowchart of an exemplary embodiment of the method 300 for training a machine learning model 2 for use in the method 100 described in connection with FIG. 1. In contrast to the method 200, this method is based on monitored training.

In step 310, training examples are provided for tensors K* of characteristic variables

$${K}_{i , j}^{t} ,$$

which characterize paired conditional probability distributions P_{D}(i|j) of observations of the sensors i and j. These training examples K* relate to normal behavior of the technical system 1.

In step 320, a distribution of disruptions p* is provided, for which it is known that they modify a tensor K* in a way that is not expected in normal operation of the technical system.

In step 330, variations \tilde{K}* are generated by applying disruptions p* sampled from the distribution to training examples K*.

In step 340, the machine learning model 2 is trained in a monitored manner using the training examples K* for normal behavior of the technical system 1, and using the variations \tilde{K}* as training examples for abnormal behavior of the technical system 1. This means that the parameters 2a, which characterize the behavior of the machine learning model 2, are directly optimized with the aim of mapping the training examples K* to a classification as normal and the variations K* to a classification as abnormal.

1-15. (canceled)

16. A method for recognizing anomalies in a technical system, behavior of which is monitored by an arrangement including n sensors, the method comprising the following steps:
for each sensor k=1, . . . , n, recording a time series
$${R}_{k}^{t}$$
of N observations of the sensor for times t=1, . . . , N;
for each time t=1, . . . , N and for the indices i=1, . . . , n and j=1, . . . , n, ascertaining a characteristic variable
$${K}_{i , j}^{t} ,$$
which characterizes a paired conditional probability distribution P_{D}(i|j) of observations of the sensors i and j;
mapping, by a trained machine model, a tensor K* of all characteristic variables
$${K}_{i , j}^{t}$$
to a classification as to whether a behavior of the technical system is normal or abnormal.

17. The method according to claim 16, wherein at least two of the sensors are selected for measured variables, between which a physical configuration of the technical system in a nominal state of the technical system facilitates a physical interaction.

18. The method according to claim 17, wherein one of the measured variables is a measure of an amount of energy fed to or present in the technical system, and wherein another of the measured variables is a measure of the amount of energy present or an energy output by the technical system.

19. The method according to claim 17, wherein at least two further of the sensors sensors are selected for further measured variables, between which the physical configuration of the technical system in a nominal state of the technical system excludes a physical interaction.

20. The method according to claim 19, wherein the further sensors are arranged on different sides of a barrier that prevents the physical interaction between the further measured variables in the nominal state of the technical system.

21. The method according to claim 16, wherein the technical system us a vehicle or an industrial plant that processes one or more reactants via of one or more processing steps to form one or more products.

22. The method according to claim 16, further comprising:
forming a control signal from the classification provided by the machine learning model; and
controlling the technical system using the control signal.

23. A method for training a machine learning model, comprising the following steps:
providing training examples for tensors K* of characteristic variables
$${K}_{i , j}^{t} ,$$
which characterize paired conditional probability distributions P_{D}(i|j) of observations of sensors i and j of the technical system;
providing a distribution of disruptions p for which it is known that they modify a tensor K* only in a way that can also occur in normal operation of the technical system;
generating positive pairs
$$( {K}_{{p}_{1}}^{*} , {K}_{{p}_{2}}^{*} ) of variations {K}_{{p}_{1}}^{*} and {K}_{{p}_{2}}^{*}$$
by applying two disruptions p₁ and P₂ sampled from the distribution to each of the training examples K*;
generating negative pairs
$$( {K}_{{p}_{1}}^{* ′} , {K}_{{p}_{2}}^{* ″} ) of variations {K}_{{p}_{1}}^{* ′} and {K}_{{p}_{2}}^{* ″}$$
by applying two disruptions p₁ and P₂ sampled from the distribution to two different training examples K*′ and K*″;
generating, using the machine learning model to be trained, processing products
$$V ( {K}_{{p}_{1}}^{*} ) , V ( {K}_{{p}_{2}}^{*} ) , V ( {K}_{{p}_{1}}^{* ′} ) and V ( {K}_{{p}_{2}}^{* ″} ) from the variations {K}_{{p}_{1}}^{*} , {K}_{{p}_{2}}^{*} , {K}_{{p}_{1}}^{* ′} and {K}_{{p}_{2}}^{* ″} ;$$
optimizing parameters that characterize a behavior of the machine learning model with the aim that
a similarity of the processing products
$$V ( {K}_{{p}_{1}}^{*} ) and V ( {K}_{{p}_{2}}^{*} )$$
that relates to positive pairs
$$( {K}_{{p}_{1}}^{*} , {K}_{{p}_{2}}^{*} )$$
is maximized, and
a similarity of the processing products
$$V ( {K}_{{p}_{1}}^{* ′} ) and V ( {K}_{{p}_{2}}^{* ″} )$$
that relates to negative pairs
$$( {K}_{{p}_{1}}^{* ′} , {K}_{{p}_{2}}^{* ″} )$$
is minimized.

24. The method according to claim 23, wherein
the machine learning model includes a feature extractor which extracts features from the tensor K* and a classification head which maps the extracted features to the desired classification of the behavior of the technical system; and
the processing products
$$V ( {K}_{{p}_{1}}^{*} ) , V ( {K}_{{p}_{2}}^{*} ) , V ( {K}_{{p}_{1}}^{* ′} ) and V ( {K}_{{p}_{2}}^{* ″} )$$
are formed by the feature extractor.

25. The method according to claim 24, wherein the classification head is trained in a monitored manner using training examples K* which are labeled with target classifications.

26. The method according to claim 23, wherein the disruptions p include:
additive normally distributed noise, and/or
a stochastic zeroing of non-diagonal elements of the tensor K*, and/or
a replacement of elements
$${K}_{i , j}^{t}$$
at a level t by elements
$${K}_{i , j}^{t + 1} , {K}_{i , j}^{t - 1}$$
at levels t+1 or t−1, and/or
an interchange of levels t, t′ of the tensor K*.

27. A method for training a machine learning model, comprising the following steps:
providing training examples for tensors K* of characteristic variables
$${K}_{i , j}^{t}$$
which characterize paired conditional probability distributions P_{D}(i|j) of observations of sensors i and j of a technical system, wherein the training examples K* relate to normal behavior of the technical system;
providing a distribution of disruptions p*, for which it is known that they modify a tensor K* in a way that is not expected in normal operation of the technical system;
generating variations K* by applying disruptions p* sampled from the distribution to training examples K*;
training the machine learning model in a monitored manner using the training examples K* for normal behavior of the technical system, and using the variations K* as training examples for abnormal behavior of the technical system.

28. A non-transitory machine-readable data carrier on which is stored machine-readable instructions for recognizing anomalies in a technical system, behavior of which is monitored by an arrangement including n sensors, the instructions, when executed by one or more computers and/or compute instances, causing one or more computers and/or compute instances to perform the following steps:
for each sensor k=1, . . . , n, recording a time series
$${R}_{k}^{t}$$
of N observations of the sensor for times t=1, . . . , N;
for each time t=1, . . . , N and for the indices i=1, . . . , n and j=1, . . . , n, ascertaining a characteristic variable
$${K}_{i , j}^{t} ,$$
which characterizes a paired conditional
probability distribution P_{D}(i|j) of observations of the sensors i and j;
mapping, by a trained machine model, a tensor K* of all characteristic variables
$${K}_{i , j}^{t}$$
to a classification as to whether a behavior of the technical system is normal or abnormal.

29. One or more computers and/or compute instances having a non-transitory machine-readable data carrier on which is stored machine-readable instructions for recognizing anomalies in a technical system, behavior of which is monitored by an arrangement including n sensors, the instructions, when executed by the one or more computers and/or compute instances, causing one or more computers and/or compute instances to perform the following steps:
for each sensor k=1, . . . , n, recording a time series
$${R}_{k}^{t}$$
of N observations of the sensor for times t=1, . . . , N;
for each time t=1, . . . , N and for the indices i=1, . . . , n and j=1, . . . , n, ascertaining a characteristic variable
$${K}_{i , j}^{t} ,$$
which characterizes a paired conditional probability distribution P_{D}(i|j) of observations of the sensors i and j;
mapping, by a trained machine model, a tensor K* of all characteristic variables
$${K}_{i , j}^{t}$$
to a classification as to whether a behavior of the technical system is normal or normal.
